(19) United States
(12) Patent Application Publication
(10) Pub. No.: US 2026/0018868 A1
(43) Pub. Date: Jan. 15, 2026

(54) FUSE ASSEMBLY FOR POWER DISTRIBUTION SYSTEM INCORPORATING ELECTRICALLY INSULATED CONNECTORS TO CONDUCTIVE ELEMENTS

(71) Applicant: Hardcraft Industries, Inc., San Jose, CA (US)

(72) Inventor: Andrew Brandt Kwiram, Piedmont, CA (US)

(73) Assignee: Hardcraft Industries, Inc., San Jose, CA (US)

(21) Appl. No.: 18/771,663

(22) Filed: Jul. 12, 2024

(51) Int. Cl. H02B 1/32; H01H 85/20

(52) U.S. Cl. CPC H02B 1/32; H01H 85/2015

(57) ABSTRACT

An electrical fuse cabinet for a power distribution system includes a housing and at least one pair of conductive elements. The at least one pair of conductive elements includes a line conductive element and a load conductive element, each of the line conductive element and the load conductive element having a fuse connector operably connected thereto configured to electrically connect a fuse. A line conductive connection terminal is electrically connected to the line conductive element and a load conductive connection terminal is electrically connected to the load conductive element. Each of the line and load conductive connection terminals are shrouded with an electrical insulating material. The line and load conductive connection terminals are each configured to be electrically connected to a respective end of an electrically insulated conductive bypass component to provide an electrically insulated conductive path to electrically bypass the fuse.

### TECHNICAL FIELD

The present disclosure relates generally to power distribution systems and more particularly to electrical fuse assemblies including cabinets for power distribution systems.

### BACKGROUND

Power distribution systems are critical infrastructures that manage the delivery of electricity from generation sources to end users. Within these systems, electrical fuse cabinets play a vital role in protecting circuits by interrupting excessive currents to prevent damage and ensure safety. Frequently the equipment inside the fuse cabinet is de-energized prior to servicing. However, servicing fuse cabinets may be performed while the equipment is energized to avoid further service disruptions, which significantly increases risk for service personnel, e.g. electrical linemen (henceforth, “linemen”). Working on energized electrical fuse cabinets (i.e. a cabinet in which energized components are directly exposed to linemen once an access panel(s), e.g., a cabinet door, is removed or opened) exposes linemen to the danger of electric shock, arc flashes, and other hazards given the numerous exposed (“bare”) conductive metal components therein. Therefore, stringent safety protocols and protective equipment are essential to mitigate the inherent risks and protect the well-being of those performing maintenance on these critical components of power distribution systems. However, even with stringent safety protocols and protective equipment, servicing electrical fuse cabinets while energized remains dangerous. Therefore, there is a need in the art for improvements.

### SUMMARY

FIGS. 1 and 2 illustrate schematic diagrams (top and side views, respectively) of a conventional electrical fuse cabinet 10 for a power distribution system. As depicted, such electrical cabinets 10 include one or more line bus bars 12a and one or more load bus bars 12b. A pair of one line bus bar 12a and one load bus bar 12b is mounted in fuse cabinet 10 with mounting elements 13 such that they are electrically separated from each other (e.g. by physical separation or spacing, or electrical insulating material) and connected electrically to the source of power and to the load, respectively. Each of the line bus bar 12a and the load bus bar 12b include a fuse connector 14 for electrically connecting and, typically, physically supporting, a fuse 16 therebetween.

Situations may arise where a lineman needs to open the fuse cabinet 10 and work therein while the components are still energized (“live”). For example, if a single fuse in a multi-phase system, in which the phases are fused separately, has experienced overload (the fuse has “burned up”) and needs to be replaced, but the other fuses are still intact, it would be inconvenient to de-energize the entire system in order to replace that single fuse. Accordingly, a lineman may electrically bypass the fuse that needs to be replaced, while keeping the system energized. For example, the lineman can electrically bypass (“jumper” or “short” in common parlance) the fuse 16 with, for example, a conductive cable 18 or the like. Such conductive cables in the prior art will typically be provided with exposed (“bare”) conductive connection points at each terminus of the cable, similar to a common automotive “jumper cable.” Therefore, on either side of the fuse 16, the bus bars 12a, 12b are typically provided with exposed or “bare metal” conductive connection points 20a, 20b (such as, but not limited to, conductive loops or screw terminals) that are electrically connected to the bus bars 12a, 12b, for connecting the conductive cable 18 to each side of the fuse 16. In this way, the lineman can connect one end of the conductive cable 18 to the conductive connection point 20a on one side of the fuse (“a line side”) and the other end of the conductive cable 18 to the conductive connection point 20b on the other side of the fuse 14 (“a load side”) to thereby electrically bypass (or “short”) the fuse 14 and maintain power transfer as they switch out the fuse 14.

During service, since many energized components within cabinet 10 are electrically exposed (i.e. are bare metal conductive elements) when the cabinet 10 is being supplied with power, a lineman is at risk of touching one of the energized components. In this conventional design, no protection for the lineman is provided against touching the energized components. For instance, the lineman's hands may come very close to the exposed conductive connection points at the ends of the conductive cable 18, or the exposed conductive connection points 20a, 20b, in the ordinary course of connecting a conductive cable 18 to electrically join the bus bar elements 12a and 12b. Furthermore, when disconnecting the conductive cable 18 from the conductive connection points 20a, 20b, if the lineman mistakenly disconnects the conductive cable 18 from the load side conductive connection point 20b first, instead of from the line side conductive connection point 20a, the disconnected exposed bare metal end of the conductive cable 18 will still be energized and pose a significant risk to the lineman and their surroundings.

An electrical fuse assembly for a power distribution system is described herein in which the conductive connection components used for electrically bypassing the fuse are electrically insulated, therefore reducing the risk of injury to a lineman by contacting them when working with the assembly. That is, the electrical fuse assembly described herein provides a completely electrically insulated (e.g., shrouded) electrical bypass for the fuse, compared to the prior art which includes several electrically uninsulated components. Specifically, for example, instead of employing exposed or bare metal conductive components (for example, but not limited to, cable terminations and bus bar connection points) for connecting a conductive cable to electrically bypass a fuse, as done in conventional assemblies and cabinets, the electrical assembly described herein uses electrically insulated conductive connection terminals that are configured to be electrically connected to a respective end of an electrically insulated conductive bypass component for transferring electrical current between the electrically insulated conductive connection terminals thereby electrically bypassing the fuse. The power distribution system may be a medium-voltage or high-voltage application and may be, for example, a power utility distribution system.

According to an aspect of this disclosure, an electrical fuse assembly for a power distribution system may be part of or used in conjunction with an electrical fuse cabinet. The electrical fuse cabinet may include a housing openable on at least one side of the housing to expose an interior of the electrical fuse cabinet. The electrical fuse cabinet may also include a fuse assembly including at least one pair of conductive elements mounted in the interior of the electrical fuse cabinet. The at least one pair of conductive elements includes a line conductive element and a load conductive element electrically separated from each other, each of the line conductive element and the load conductive element having a respective fuse connector operably connected thereto for electrically connecting a fuse between the line conductive element and the load conductive element. The housing also includes a line conductive connection terminal electrically connected to the line conductive element and a load conductive connection terminal electrically connected to the load conductive element, with the fuse connector electrically connected to the line conductive connection terminal and the load conductive connection terminal, respectively. Each of the line conductive connection terminal and the load conductive connection terminal are electrically insulated with an electrical insulating material, for example by being shrouded with an electrical insulating material. A fuse is electrically connected by the fuse connectors for transferring electrical current from the line conductive element to the load conductive element through the fuse. A conductive bypass component is electrically connected to the line conductive connection terminal at a first end of the conductive bypass component and electrically connected to the load conductive connection terminal at a second end of the conductive bypass component. The conductive bypass component is configured to transfer electrical current from the line conductive connection terminal to the load conductive connection terminal to electrically bypass the fuse.

According to an embodiment of any paragraph(s) of this summary, the line conductive connection terminal and the load conductive connection terminal are medium-voltage grounding bushings.

According to an embodiment of any paragraph(s) of this summary, the line conductive connection terminal and the load conductive connection terminal are medium-voltage shallow bushing wells as are commonly employed for electrical connections to transformers mounted in oil-filled enclosures.

According to an embodiment of any paragraph(s) of this summary, the line conductive connection terminal and the load conductive connection terminal include a threaded portion for receiving the respective end of the conductive bypass component.

According to an embodiment of any paragraph(s) of this summary, the conductive bypass component includes an electrically insulated conductive bypass cable, a first medium-voltage loadbreak elbow electrically coupled to a first end of the conductive bypass cable and a second medium-voltage loadbreak elbow electrically connected to a second end of the conductive bypass cable, and a first medium-voltage loadbreak insert electrically coupled to the first loadbreak elbow and a second loadbreak insert electrically coupled to the second loadbreak elbow. The first and second loadbreak inserts are respectively electrically connected to the line conductive connection terminal and the load conductive connection terminal.

According to an embodiment of any paragraph(s) of this summary, the at least one pair of conductive elements includes a plurality of pairs of conductive elements.

According to an embodiment of any paragraph(s) of this summary, the housing includes a plurality of compartments, each of the plurality of compartments being configured to house a respective one of the plurality of pairs of conductive elements or a single element of a pair of conductive elements.

According to an embodiment of any paragraph(s) of this summary, the plurality of compartments are each electrically insulated from each other.

According to another aspect of this disclosure, an electrical fuse assembly includes at least one pair of conductive elements. The at least one pair of conductive elements includes a line conductive element and a load conductive element electrically separated from each other, each of the line conductive element and the load conductive element having a respective fuse connector operably connected thereto for electrically connecting a fuse between the line conductive element and the load conductive element. A line conductive connection terminal is electrically connected to the line conductive element and a load conductive connection terminal is electrically connected to the load conductive element, with the respective fuse connectors electrically connected to the line conductive connection terminal and the load conductive connection terminal. Each of the line conductive connection terminal and the load conductive connection terminal are electrically insulated with an electrical insulating material, for example by being shrouded with an electrical insulating material. A conductive bypass component is electrically connected to the line conductive connection terminal at a first end of the conductive bypass component and electrically connected to the load conductive connection terminal at a second end of the conductive bypass component. The conductive bypass component is configured to transfer electrical current from the line conductive connection terminal to the load conductive connection terminal to electrically bypass the fuse.

According to an embodiment of any paragraph(s) of this summary, the line conductive connection terminal and the load conductive connection terminal are medium-voltage grounding bushings.

According to an embodiment of any paragraph(s) of this summary, the line conductive connection terminal and the load conductive connection terminal are medium-voltage shallow bushing wells as are commonly employed for electrical connections to transformers mounted in oil-filled enclosures.

According to an embodiment of any paragraph(s) of this summary, the line conductive connection terminal and the load conductive connection terminal include a threaded portion for receiving the respective end of the conductive bypass component.

According to an embodiment of any paragraph(s) of this summary, the conductive bypass component includes an electrically insulated conductive bypass cable, a first medium-voltage loadbreak elbow electrically coupled to a first end of the conductive bypass cable and a second medium-voltage loadbreak elbow electrically connected to a second end of the conductive bypass cable, and a first medium-voltage loadbreak insert electrically coupled to the first loadbreak elbow and a second medium-voltage loadbreak insert electrically coupled to the second loadbreak elbow, wherein the first and second loadbreak inserts are respectively electrically connected to the line conductive connection terminal and the load conductive connection terminal.

According to an embodiment of any paragraph(s) of this summary, the at least one pair of conductive elements includes a plurality of pairs of conductive elements.

According to an embodiment of any paragraph(s) of this summary, the assembly may be mounted inside a housing that includes a plurality of compartments, each of the plurality of compartments being configured to house a respective one of the plurality of pairs of conductive elements.

According to an embodiment of any paragraph(s) of this summary, the plurality of compartments are each electrically insulated from each other.

According to another aspect of the disclosure, an electrical fuse cabinet for a power distribution system includes a housing openable on at least one side of the housing to expose an interior of the electrical fuse cabinet. The electrical fuse cabinet also includes at least one pair of conductive elements mounted in the interior of the electrical fuse cabinet. The at least one pair of conductive elements includes a line conductive element and a load conductive element electrically separated from each other, each of the line conductive element and the load conductive element having a respective fuse connector operably connected thereto and configured to electrically connect a fuse between the line conductive element and the load conductive element. A line conductive connection terminal is electrically connected to the line conductive element and a load conductive connection terminal is electrically connected to the load conductive element, with the respective fuse connectors electrically connected to the line conductive connection terminal and the load conductive connection terminal. Each of the line conductive connection terminal and the load conductive connection terminal are electrically insulated with an electrical insulating material, for example by being shrouded with an electrical insulating material. The line conductive connection terminal and the load conductive connection terminal are each configured to be electrically connected to a respective end of an electrically insulated conductive bypass component for transferring electrical current from the line conductive connection terminal to the load conductive connection terminal to electrically bypass the fuse.

According to an embodiment of any paragraph(s) of this summary, the line conductive connection terminal and the load conductive connection terminal are medium-voltage grounding bushings.

According to an embodiment of any paragraph(s) of this summary, the line conductive connection terminal and the load conductive connection terminal are medium-voltage shallow bushing wells commonly used for electrical connections to transformers mounted in oil-filled enclosures.

According to an embodiment of any paragraph(s) of this summary, the line conductive connection terminal and the load conductive connection terminal include a threaded portion for receiving the respective end of the conductive bypass component.

According to an embodiment of any paragraph(s) of this summary, the at least one pair of conductive elements includes a plurality of pairs of conductive elements.

According to an embodiment of any paragraph(s) of this summary, the housing includes a plurality of compartments, each of the plurality of compartments being configured to house a respective one of the plurality of pairs of conductive elements.

According to an embodiment of any paragraph(s) of this summary, the plurality of compartments are each electrically insulated from each other.

The following description and the annexed drawings set forth in detail certain illustrative embodiments described in this disclosure. These embodiments are indicative, however, of but a few of the various ways in which the principles of this disclosure may be employed. Other objects, advantages and novel features will become apparent from the following detailed description when considered in conjunction with the drawings.

### BRIEF DESCRIPTION OF DRAWINGS

The annexed drawings show various aspects of the disclosure.

FIG. 1 is a schematic diagram of a prior art electrical fuse cabinet for a power distribution system from a top view.

FIG. 2 is a schematic diagram of the prior art electrical fuse cabinet for a power distribution system of FIG. 1 from a side view.

FIG. 3 is a schematic diagram of an electrical fuse cabinet for a power distribution system from a top view.

FIG. 4 is a schematic diagram of the electrical fuse cabinet for a power distribution system of FIG. 3 from a side view.

FIG. 5 is a perspective view of an electrical fuse cabinet for a power distribution system.

FIG. 6 is another perspective view of an electrical fuse cabinet for a power distribution system.

FIG. 7 is a schematic diagram of an electrical fuse cabinet assembly for a power distribution system from a top view.

FIG. 8 is a schematic diagram of the electrical fuse cabinet assembly for a power distribution system of FIG. 7 from a side view.

FIG. 9 is a front perspective view of a shallow bushing well of an electrical fuse cabinet for a power distribution system.

FIG. 10 is a rear perspective view of a shallow bushing well of an electrical fuse cabinet for a power distribution system.

FIG. 11 is a side cross-sectional view of a shallow bushing well of an electrical fuse cabinet for a power distribution system.

FIG. 12 is a perspective view of a loadbreak insert for use with an electrical fuse cabinet assembly for a power distribution system.

FIG. 13 is a perspective view of a loadbreak elbow for use with an electrical fuse cabinet assembly for a power distribution system.

FIG. 14 is a perspective view of the loadbreak elbow of FIG. 13 electrically connected to a electrically insulated conductive bypass cable for use with an electrical fuse cabinet assembly for a power distribution system.

FIG. 15 is a perspective view of a grounding bushing of an electrical fuse cabinet for a power distribution system.

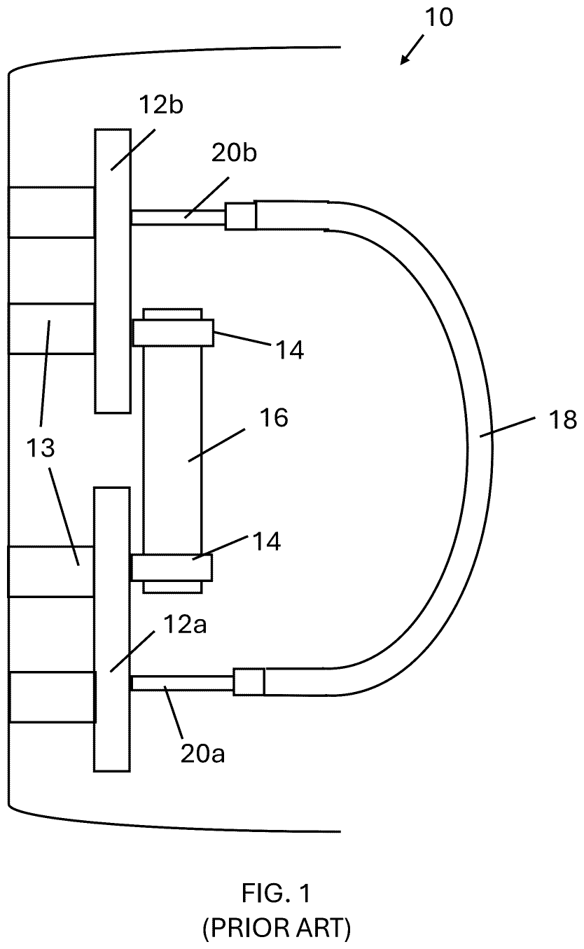

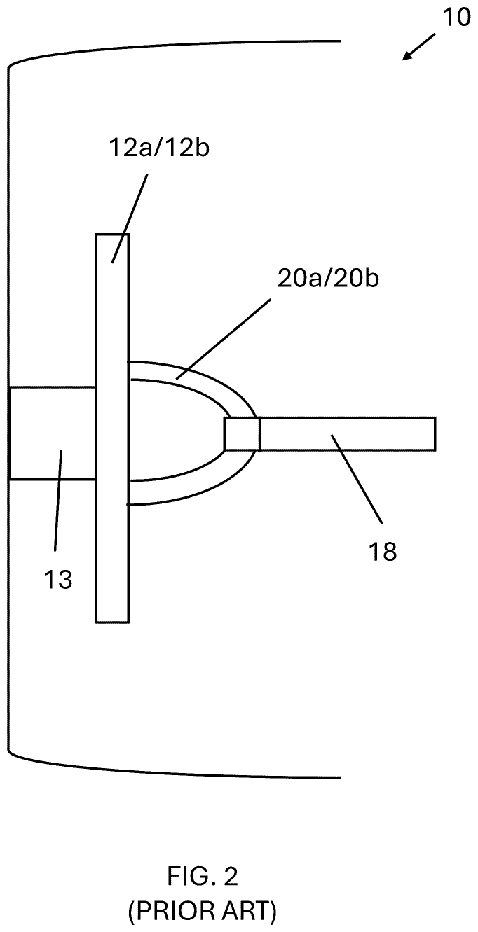

### DETAILED DESCRIPTION

Described herein is an electrical fuse assembly for a power distribution system, and an associated electrical fuse cabinet assembly in which the disclosed electrical fuse assembly may be used. The electrical fuse assembly disclosed herein reduces the risks associated with conventional fuse assemblies when a lineman is working thereon. Specifically, the electrical fuse assembly and associated cabinet disclosed herein employs conductive connection terminals that are electrically insulated in an electrical insulating material, instead of being exposed to the lineman, thereby reducing or eliminating the risk of the lineman contacting such conductive connection terminals when working with the fuse assembly and/or cabinet. The disclosed fuse assembly further greatly reduces the risk of harm if the lineman leaves a conductive cable with exposed (“bare”) terminal elements connected to the energized and exposed (bare metal) conductive connection point attached to an energized conductive element (e.g., an energized bus bar) but disconnects the other end of such conductive cable from the load conductive connection point (e.g., a connection element connected to the load bus bar). Additionally, by using conductive connection terminals that are electrically insulated in an electrical insulating material and project away from the remaining potentially bare or exposed conductive elements, e.g. fuse connectors, the lineman's hands do not need to come as close to the energized exposed components in the assembly and/or within the cabinet as they do in a conventional cabinet design.

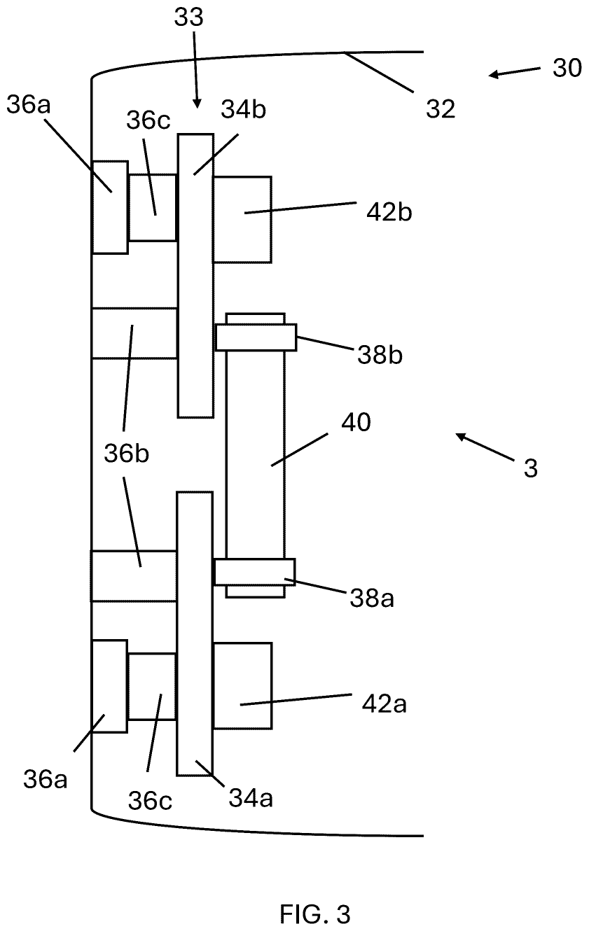

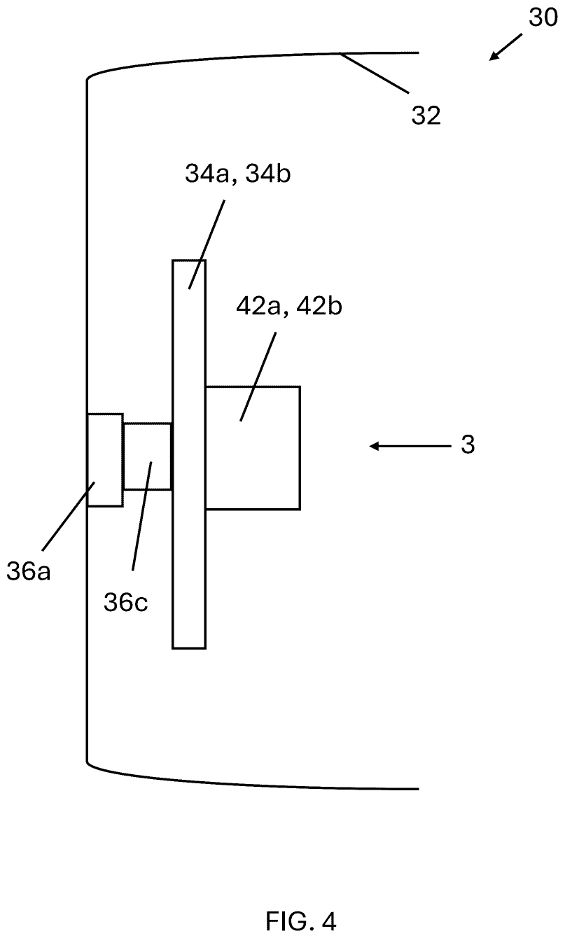

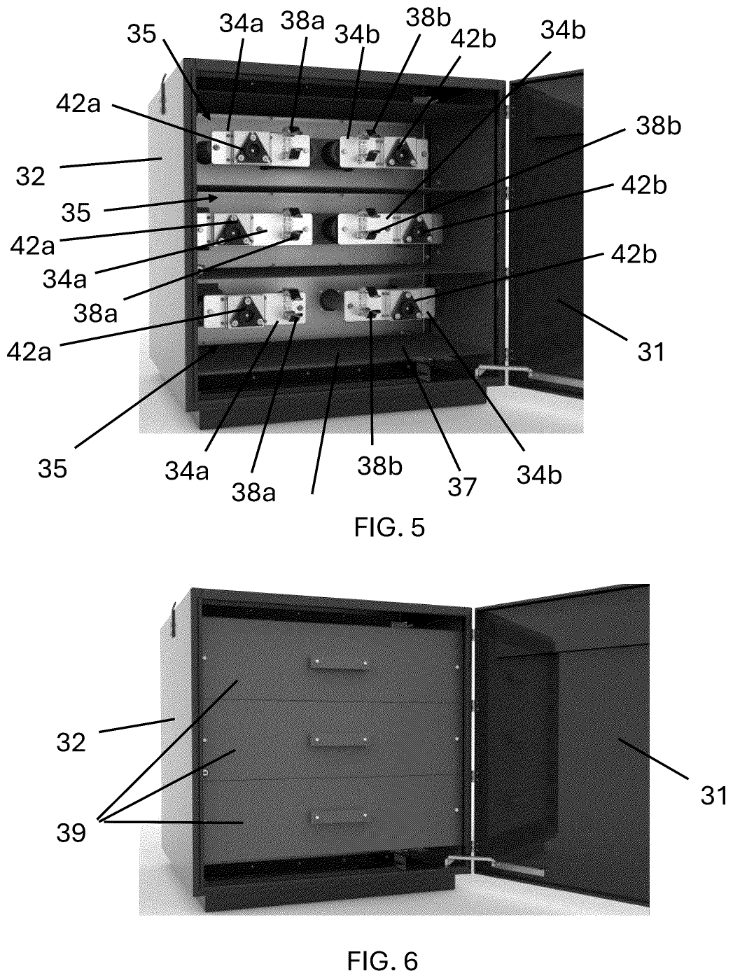

Turning to FIGS. 3 and 4, an exemplary electrical fuse cabinet 30 is depicted. FIG. 3 depicts a schematic top/bottom view of the cabinet 30, while FIG. 4 depicts a schematic side view of the cabinet 30. As depicted, the cabinet 30 includes a housing 32 that is openable on at least one side of the housing 32, for example a front side (a right side in the schematics of FIGS. 3 and 4) to expose an interior of the cabinet 30. With additional reference to the embodiments of the cabinet 30 depicted in FIGS. 5 and 6, for example, the cabinet 30 may include a door 31 on the front side of the cabinet 30, hingedly attached to the housing 32 for exposing the interior of the cabinet 30. It will be understood that the housing 32 may be openable on one side in another manner, such as with a wholly or partially removable wall of the housing 32 instead of the hinged door 31.

Mounted inside the cabinet 30 may be a fuse assembly 3 that may include at least one pair 33 of conductive elements (for example, but not limited to, bus bars) 34a, 34b including a line conductive element (for example, but not limited to, a line bus bar 34a) and a load conductive element (for example, but not limited to, a load bus bar 34b). The line conductive element 34a and the load conductive element 34b are mounted such that they are electrically separated from each other. Each of the line conductive element 34a and the load conductive element 34b may be mounted to the housing 32 with a plurality of mounting components 36. For example, in the depicted embodiment, the mounting components include mounting blocks 36a, bushing wells 36b incorporating conductive elements (e.g., long bushing wells) and standoff insulators 36c. It will be understood that any other suitable mounting component or combination of mounting components may be applied to mount the pair 33 of conductive elements 34a, 34b to the housing 32. The line conductive element 34a is configured to receive electrical power from the electrical source. The load conductive element 34b is configured to deliver electrical power to the load.

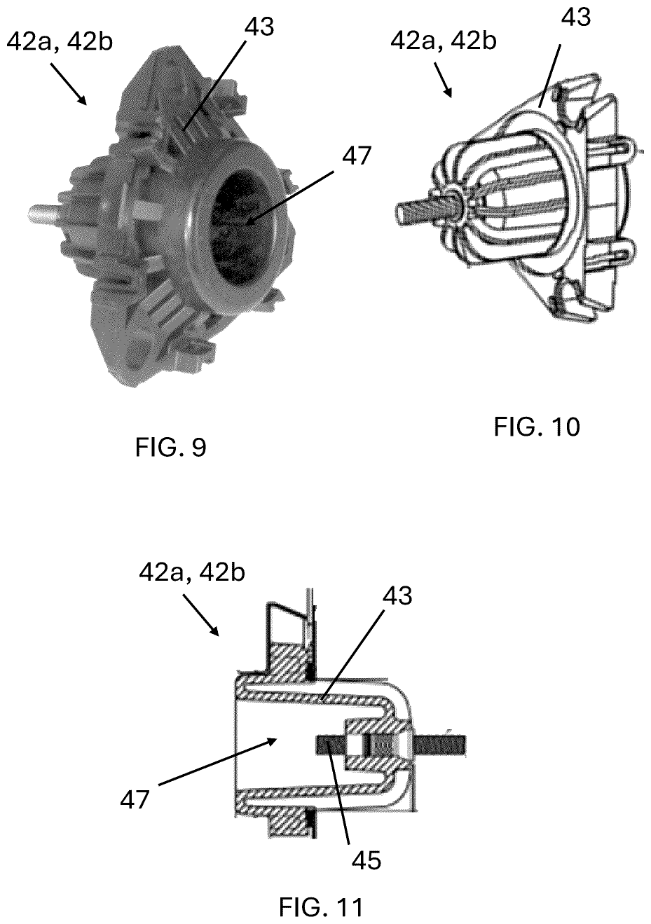

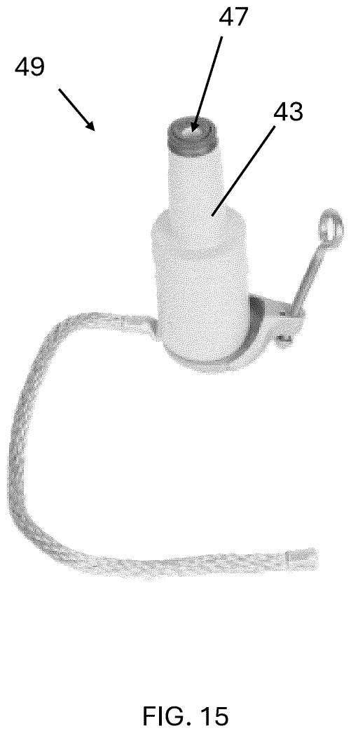

Each of the line conductive element 34a and the load conductive element 34b include a respective fuse connector 38a, 38b electrically connected to the conductive elements 34a, 34b. The fuse connectors 38a, 38b are configured to electrically connect a fuse 40 between the line conductive element 34a and the load conductive element 34b for transferring power from the line conductive element 34a to the load conductive element 34b through the fuse 40. Each of the line conductive element 34a and the load conductive element 34b also include a respective conductive connection terminal 42a, 42b electrically connected to the respective conductive element 34a, 34b adjacent to the respective fuse connectors 38a, 38b such that the fuse connectors 38a, 38b are mounted in between the conductive connection terminals 42a, 42b. That is, as depicted, the line conductive element 34a includes a line conductive connection terminal 42a electrically connected to the line fuse connector 38a, distal to the load conductive element 34b relative to the line fuse connector 38a. Similarly, the load conductive element 34b includes a load conductive connection terminal 42b electrically connected to the load fuse connector 38b, distal to the line conductive element 34a relative to the load fuse connector 38a. It is understood that other arrangements and locations for mounting the line conductive connection terminal 42a and the load conductive connection terminal 42b may be employed. The respective conductive connection terminals 42a, 42b are each electrically insulated with an electrical insulating material. For example, each of the line conductive connection terminal 42a and the load conductive connection terminal 42b may be in the form of a shallow bushing well. An exemplary, industry standard shallow bushing well is depicted in FIGS. 9-11. As depicted, the line conductive connection terminal 42a and the load conductive connection terminal 42b (in some embodiments, shallow bushing wells) include an electrically insulated shrouding 43 formed of an electrical insulating material that protects a conductive connection terminal element 45 within a recessed well 47 of the shrouding 43. The conductive connection terminal element 45 may include a threaded portion for receiving the loadbreak insert 50a, 50b. In an alternative embodiment, each of the line conductive connection terminal 42a and the load conductive connection terminal 42b may be replaced with a grounding bushing 49. An exemplary industry-standard grounding bushing 49 is depicted in FIG. 15. As depicted, the grounding bushing 49 includes the electrically insulated shrouding 43 formed of the electrical insulating material that protects the conductive connection terminal element 45 within a recessed well 47 of the shrouding 43. The grounding bushing may be, for example, a medium-voltage grounding bushing.

The electrical fuse cabinet 30 may include a plurality of pairs 33 of conductive elements (e.g., a plurality of pairs 33 of bus bars), as depicted in the embodiment of FIGS. 5 and 6. In such an embodiment, the housing 32 includes a plurality of compartments 35, each of the plurality of compartments 35 being configured to house a respective one of the plurality of pairs 33 of conductive elements. Each of the compartments 35 are configured to be electrically insulated from each other, for example with electrically insulating panels 37 defining each compartment 35. Additionally, each of the compartments 35 may include a compartment cover 39 covering a front of each compartment 35. Such covers 39 may be wholly or partially removable from a front of each compartment 35 to expose the compartments 35 on at least one side (a front side).

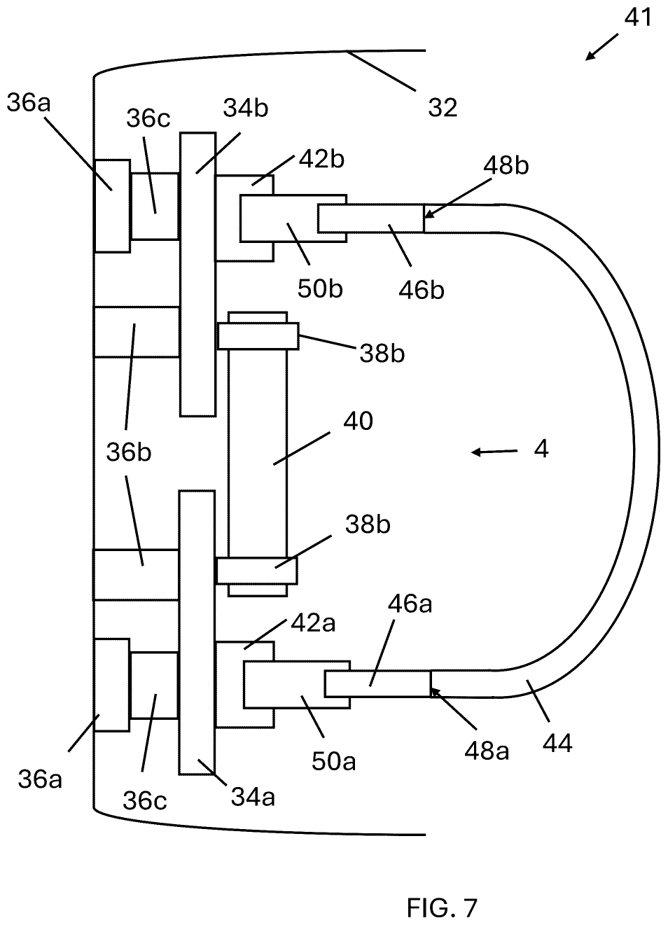

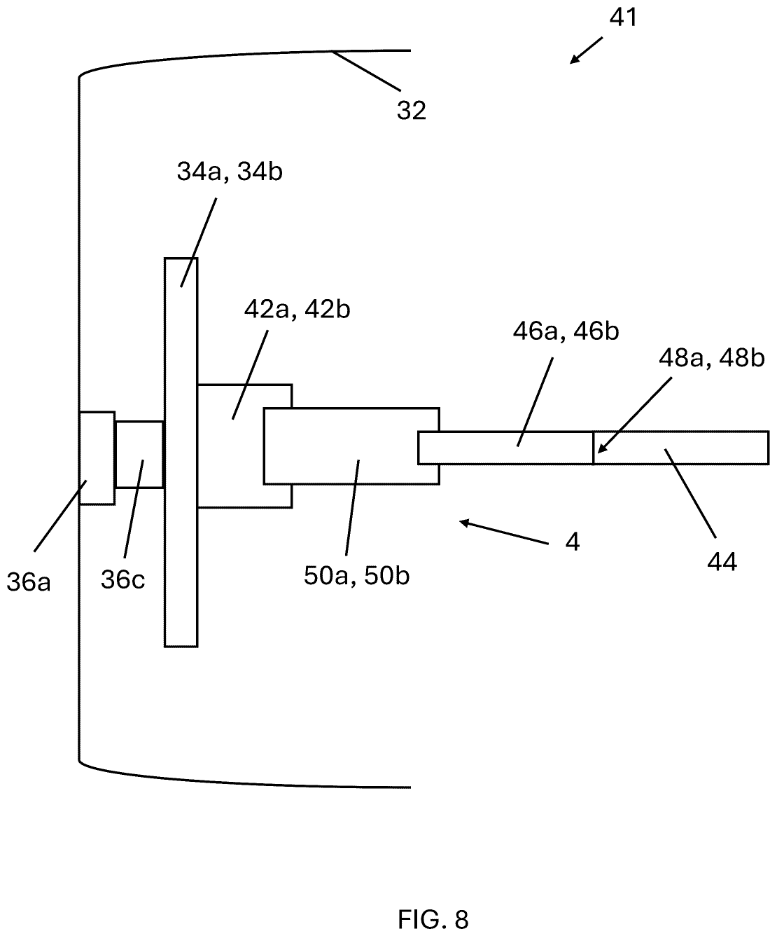

The conductive connection terminals 42a, 42b are each configured to be electrically connected to a respective end of a conductive bypass component for transferring electrical current from the line conductive connection terminal 42a to the load conductive connection terminal 42b to electrically bypass the fuse 40. For example, an exemplary electrical fuse assembly 4 and a fuse cabinet assembly 41 in which the conductive connection terminals 42a, 42b are electrically connected to an electrically insulated conductive bypass component for transferring electrical current will now be described with reference to FIGS. 7 and 8. As depicted in the exemplary embodiment of FIGS. 7 and 8, the conductive bypass component may include an electrically insulated conductive bypass cable 44 having a first and second loadbreak elbow 46a, 46b electrically coupled to a first and second end 48a, 48b of the conductive bypass cable 44, respectively. The conductive bypass component may additionally therefore include a first and second loadbreak insert 50a, 50b electrically coupled to the first and second loadbreak elbows 46a, 46b, respectively. The first and second loadbreak inserts 50a, 50b are configured to electrically connect to the respective conductive connection terminals 42a, 42b. It is understood that the loadbreak elbows 46a, 46b and the loadbreak inserts 50a, 50b may be industry-standard loadbreak components. Particularly for medium-voltage applications, industry-standard loadbreak components may be used.

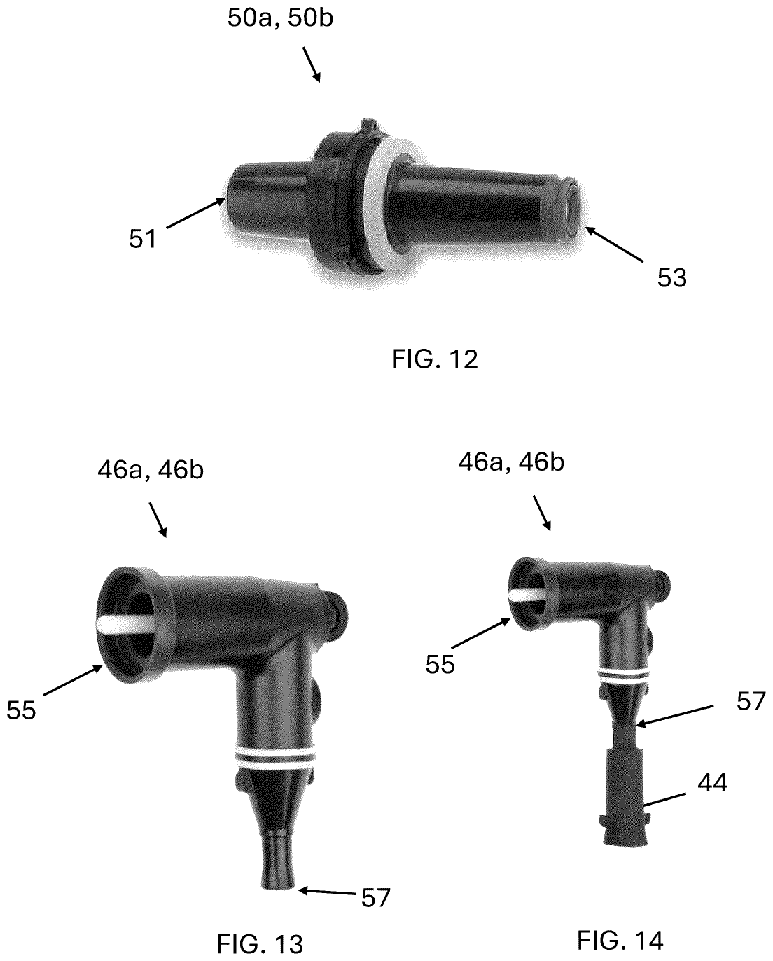

An exemplary loadbreak insert 50a, 50b for electrically connecting to the conductive connection terminals 42a, 42b (e.g., shallow bushing wells) is depicted in FIG. 12, and an exemplary loadbreak elbow 46a, 46b for electrically connecting to the loadbreak insert 50a, 50b is depicted in FIGS. 13 and 14. FIG. 13 depicts the exemplary loadbreak elbow 46a, 46b in isolation, while FIG. 14 depicts the exemplary loadbreak elbow 46a, 46b electrically connected to an end 48a, 48b of the conductive bypass cable 44. Both the loadbreak insert 50a, 50b, the loadbreak elbow 46a, 46b, and the conductive bypass cable 44 have an electrically insulated outer cover, such that all conductive components of each are housed within the respective electrically insulated outer covers. The loadbreak insert 50a, 50b includes a first end 51 for being received by the recessed well 47 of the conductive connection terminals 42a, 42b and electrically connecting with the conductive connection terminal element 45, and a second end 53 for receiving the loadbreak elbow 46a, 46b. The loadbreak elbow 46a, 46b includes a first end 55 for being received by the second end 53 of the loadbreak insert 50a, 50b and electrically connecting with the loadbreak insert 50a, 50b, and a second end 57 for electrically connecting with the conductive bypass cable 44. In the embodiment in which the line conductive connection terminal 42a and the load conductive connection terminal 42b are in the form of a grounding bushing 49, the grounding bushing 49 is configured to be electrically connected to the loadbreak elbows 46a, 46b, removing the need for the loadbreak inserts 50a, 50b and the shallow bushing wells 42a, 42b.

When the conductive connection terminals 42a, 42b are each respectively connected to the loadbreak inserts 50a, 50b (or directly to the loadbreak elbows 46a, 46b), the loadbreak inserts 50a, 50b are respectively connected to the loadbreak elbows 46a, 46b, and the loadbreak elbows 46a, 46b are respectively connected to the conductive bypass cable 44, an electrical bypass or shorting path is created to transfer power from the line conductive element 34a to the load conductive element 34b and electrically bypass the fuse 40. This allows a lineman to replace or perform maintenance on the fuse 40 without disrupting the transfer of power.

Although in the present disclosure the assemblies 3 and 4 are disclosed as disposed inside cabinet assemblies 30 and 41, respectively, in other embodiments the assemblies 3 and 4 may be disposed not inside cabinet assemblies but may be exposed or housed inside structures distinct from cabinet assemblies as disclosed herein. Also, although bus bars are given as an example of the conductive elements 34a, 34b described herein, it is understood that the conductive elements 34a, 34b may be any other conductive element suitable to electrically connect the line power, fuse connectors and conductive connection terminals.

Although the above disclosure has been shown and described with respect to a certain preferred embodiment or embodiments, it is obvious that equivalent alterations and modifications will occur to others skilled in the art upon the reading and understanding of this specification and the annexed drawings. In particular, regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments. In addition, while a particular feature may have been described above with respect to only one or more of several illustrated embodiments, such feature may be combined with one or more other features of the other embodiments, as may be desired and advantageous for any given or particular application.

### Definitions

The following includes definitions of selected terms employed herein. The definitions include various examples or forms of components that fall within the scope of a term and that may be used for implementation. The examples are not intended to be limiting. Both singular and plural forms of terms may be within the definitions.

As used herein, an “operable connection” or “operable coupling,” or a connection by which entities are “operably connected” or “operably coupled” is one in which the entities are connected in such a way that the entities may perform as intended. An operable connection may be a direct connection or an indirect connection in which an intermediate entity or entities cooperate or otherwise are part of the connection or are in between the operably connected entities. In the context of signals, an “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

What is claimed is:

1. An electrical fuse cabinet assembly for a power distribution system, the electrical fuse cabinet assembly comprising:
an electrical fuse cabinet including:
a housing openable on at least one side of the housing to expose an interior of the electrical fuse cabinet;
at least one pair of conductive elements mounted in the interior of the electrical fuse cabinet, the at least one pair of conductive elements including:
a line conductive element and a load conductive element electrically separated from each other, each of the line conductive element and the load conductive element having a respective fuse connector operably connected thereto for electrically connecting a fuse between the line conductive element and the load conductive element; and
a line conductive connection terminal electrically connected to the line conductive element and a load conductive connection terminal electrically connected to the load conductive element, the respective fuse connectors electrically connected to the line conductive connection terminal and the load conductive connection terminal, each of the line conductive connection terminal and the load conductive connection terminal being shrouded with an electrical insulating material;
a fuse electrically connected to the fuse connectors for transferring electrical energy from the line conductive element to the load conductive element; and
an electrically insulated conductive bypass component configured to be electrically connected to the line conductive connection terminal at a first end of the conductive bypass component and electrically connected to the load conductive connection terminal at a second end of the conductive bypass component, the conductive bypass component being configured to transfer electrical current from the line conductive connection terminal to the load conductive connection terminal to electrically bypass the fuse.

2. The electrical fuse cabinet assembly according to claim 1, wherein the line conductive connection terminal and the load conductive connection terminal are grounding bushings.

3. The electrical fuse cabinet assembly according to claim 1, wherein the line conductive connection terminal and the load conductive connection terminal are shallow bushing wells.

4. The electrical fuse cabinet assembly according to claim 1, wherein the line conductive connection terminal and the load conductive connection terminal include a threaded portion for receiving the respective end of the conductive bypass component.

5. The electrical fuse cabinet assembly according to claim 1, wherein the conductive bypass component includes:
an electrically insulated conductive bypass cable or rod,
a first loadbreak elbow electrically coupled to a first end of the conductive bypass cable or rod and a second loadbreak elbow electrically connected to a second end of the conductive bypass cable or rod, and
a first loadbreak insert electrically coupled to the first loadbreak elbow and a second loadbreak insert electrically coupled to the second loadbreak elbow, wherein the first and second loadbreak inserts are respectively electrically connected to the line conductive connection terminal and the load conductive connection terminal.

6. The electrical fuse cabinet assembly according to claim 1, wherein the at least one pair of conductive elements includes a plurality of pairs of conductive elements.

7. The electrical fuse cabinet assembly according to claim 6, wherein the housing includes a plurality of compartments, each of the plurality of compartments being configured to house a respective one of the plurality of pairs of conductive elements.

8. An electrical fuse assembly for a power distribution system, the electrical fuse assembly comprising:
at least one pair of conductive elements including a line conductive element and a load conductive element electrically separated from each other, each of the line conductive element and the load conductive element having a respective fuse connector operably connected thereto for securing a fuse electrically connected between the line conductive element and the load conductive element; and
a line conductive connection terminal electrically connected to the line conductive element and a load conductive connection terminal electrically connected to the load conductive element, the respective fuse connectors electrically connected to the line conductive connection terminal and the load conductive connection terminal, each of the line conductive connection terminal and the load conductive connection terminal being shrouded with an electrical insulating material, the line conductive connection terminal configured to receive a first end of a conductive bypass component configured to be electrically connected to the line conductive connection terminal at the first end of the conductive bypass component, the load conductive connection terminal configured to receive a second end of the conductive bypass component configured to be electrically connected to the load conductive connection terminal at the second end of the conductive bypass component, the conductive bypass component being configured to transfer electrical current from the line conductive connection terminal to the load conductive connection terminal to electrically bypass the fuse.

9. The electrical fuse assembly according to claim 8, wherein the line conductive connection terminal and the load conductive connection terminal are grounding bushings.

10. The electrical fuse assembly according to claim 8, wherein the line conductive connection terminal and the load conductive connection terminal are shallow bushing wells.

11. The electrical fuse assembly according to claim 8, wherein the line conductive connection terminal and the load conductive connection terminal include a threaded portion for receiving the respective end of the conductive bypass component.

12. The electrical fuse assembly according to claim 8, wherein the conductive bypass component includes:
an electrically insulated conductive bypass cable or rod,
a first loadbreak elbow electrically coupled to a first end of the conductive bypass cable or rod and a second loadbreak elbow electrically connected to a second end of the conductive cable or rod, and
a first loadbreak insert electrically coupled to the first loadbreak elbow and a second loadbreak insert electrically coupled to the second loadbreak elbow, wherein the first and second loadbreak inserts are respectively electrically connected to the line conductive connection terminal and the load conductive connection terminal.

13. The electrical fuse assembly according to claim 8, wherein the at least one pair of conductive elements includes a plurality of pairs of conductive elements.

14. The electrical fuse assembly according to claim 13, comprising a housing including a plurality of compartments, each of the plurality of compartments being configured to house a respective one of the plurality of pairs of conductive elements.

15. An electrical fuse cabinet for a power distribution system, the electrical fuse cabinet comprising:
a housing openable on at least one side of the housing to expose an interior of the electrical fuse cabinet;
at least one pair of conductive elements mounted in the interior of the electrical fuse cabinet, the at least one pair of conductive elements including:
a line conductive element and a load conductive element electrically separated from each other, each of the line conductive element and the load conductive element having a respective fuse connector operably connected thereto and configured to electrically connect a fuse between the line conductive element and the load conductive element; and
a line conductive connection terminal electrically connected to the line conductive element and a load conductive connection terminal electrically connected to the load conductive element with the respective fuse connectors electrically connected to the line conductive connection terminal and the load conductive connection terminal, each of the line conductive connection terminal and the load conductive connection terminal being shrouded with an electrical insulating material;
wherein the line conductive connection terminal and the load conductive connection terminal are each configured to be electrically connected to a respective end of an electrically insulated conductive bypass component for transferring electrical current from the line conductive connection terminal to the load conductive connection terminal to electrically bypass the fuse.

16. The electrical fuse cabinet assembly according to claim 15, wherein the line conductive connection terminal and the load conductive connection terminal are grounding bushings.

17. The electrical fuse cabinet according to claim 15, wherein the line conductive connection terminal and the load conductive connection terminal are shallow bushing wells.

18. The electrical fuse cabinet according to claim 15, wherein the line conductive connection terminal and the load conductive connection terminal include a threaded portion for receiving the respective end of the conductive bypass component.

19. The electrical fuse cabinet according to claim 15, wherein the at least one pair of conductive elements includes a plurality of pairs of conductive elements.

20. The electrical fuse cabinet according to claim 19, wherein the housing includes a plurality of compartments, each of the plurality of compartments being configured to house a respective one of the plurality of pairs of conductive elements.
